(19) United States
(12) Patent Application Publication
(10) Pub. No.: US 2008/0035264 A1
(43) Pub. Date: Feb. 14, 2008

(54) Hot press for electronic devices and hot pressing method

(75) Inventor: Yi-Yin Chen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/891,799

(22) Filed: Aug. 13, 2007

(30) Foreign Application Priority Data
Aug. 11, 2006 (TW) 95129583

(51) Int. Cl. B29C 65/24

(52) U.S. Cl. 156/64; 156/367; 156/378

(57) ABSTRACT

An exemplary hot press (2) for bonding electronic devices (31, 32) includes a hot-head (24) and a control device (28). The hot-head includes a plurality of heating members (241). The hot-head includes a plurality of heating members (241) and a pressing end (243) joining same ends of the heating members. The pressing end is configured for pressing a bonding portion of one of the electronic devices. The heating members are configured for converting input electrical energy into heat and transferring the heat to the bonding portion of said one of the electronic devices via the pressing end. The control device is electrically connected with the heating members and configured for controlling the amount of the heat generated by each heating member.

### FIELD OF THE INVENTION

The present invention relates to a hot press which can for example be used to attach two electronic devices together, and a hot pressing method employing the hot press.

### GENERAL BACKGROUND

Various printed circuit boards (PCBs) have very complex wiring patterns and very high density wiring patterns. Typically, this is because of the need to provide patterns of complex wiring connections between electronic components that are fixed on the PCB in close proximity to one another. Thus in many cases, it is not possible to produce all the wiring patterns on a single piece of board material. In these cases, it is usual practice to divide the wiring pattern into a plurality of groups, and print the wiring pattern groups on respective substrate boards (hereinafter, “substrates”). Then the substrates are superposed one over another in a predetermined order and pressed together, to provide a single unified printed circuit board. This kind of printed circuit board is usually referred to as a multilayer printed circuit board (hereinafter, “multilayer board”). When the substrates are mechanically pressed together, the wiring pattern groups are simultaneously electrically connected to one another. Typically, the substrates are pressed together by means of a hot press machine (hereinafter, “hot press”).

Referring to FIG. 5, a typical hot press 1 includes a working table 11, a supporting plate 13, and a hot-head 15. The supporting plate 13 is disposed on the working table 11, and can move relative to the working table 11. The hot-head 15 is disposed above the supporting plate 13.

Referring also to FIG. 6, the hot-head 15 includes a heating body 151 and a pressing end 153. The heating body 151 is configured to convert electrical energy to heat energy, and provide the heat to the pressing end 153. The pressing end 153 is at a bottom end of the hot-head 15. The pressing end 153 is configured to mechanically press on the top one of a stack of electronic devices, and transfer the heat to the electronic devices to bond the electronic devices together.

Before operating the hot press 1, two electronic devices are prepared. The electronic devices can for example be a printed circuit board 17 and a liquid crystal panel 19. An anisotropic conductive adhesive layer 18 is sandwiched between the printed circuit board 17 and the liquid crystal panel 19. The printed circuit board 17 and the liquid crystal panel 19 are fixed in position, with the liquid crystal panel 19 being supported by the supporting plate 13.

In operation of the hot press 1, the supporting plate 13 having the printed circuit board 17 and the liquid crystal panel 19 fixed thereat is moved in a horizontal plane, so that bonding portions of the printed circuit board 17 and the liquid crystal panel 19 are aligned with the hot-head 15. The hot-head 15 is moved vertically down until the pressing end 153 abuts and presses the bonding portion of the printed circuit board 17. The heating body 151 is electrified, and converts the electrical energy to heat energy. The heat is transferred to the press portion 153, and then is transferred to the bonding portions of the printed circuit board 17 and liquid crystal panel 19 and the adhesive layer 18. Thereby, the adhesive layer 18 melts, and the printed circuit board 17 is mechanically and electrically connected with the liquid crystal panel 19 via the adhesive layer 18.

However, when the heat is provided by the heating body 151 to the pressing end 153, the heat does not conduct to the pressing end 153 uniformly. In particular, there is a difference between the speed of heat transmission in a center portion of the heating body 151 and the speed of heat transmission at peripheral edge portions of the heating body 151. Therefore a surface temperature of a bottom face of the pressing end 153 is liable to be non-uniform. This non-uniformity may bring about defects in the bonding between the two electronic devices 17, 19. For example, unwanted protrusions or cold solder joints may occur. When this happens, the mechanical connection and the electrical connection between the two electronic devices 17, 19 may be impaired.

Thus, a new hot press that can overcome the above-described problems is desired. A method employing such a hot press is also desired.

### SUMMARY

In one preferred embodiment, a hot press for bonding at least two electronic devices together includes a hot-head and a control device. The hot-head includes a plurality of heating members and a pressing end joining same ends of the heating members. The pressing end is configured for pressing a bonding portion of one of the electronic devices. The heating members are configured for converting input electrical energy into heat and transferring the heat to the bonding portion of said one of the electronic devices via the pressing end. The control device is electrically connected with the heating members and configured for controlling the amount of the heat generated by each heating member.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is an isometric view of a hot press according to an exemplary embodiment of the present invention, showing an electronic device assemblage mounted on the hot press.

FIG. 2 is an enlarged, right side, partly cutaway view of certain parts of the hot press and the electronic device assemblage of FIG. 1, showing a temperature sensor of the hot press, and also showing aspects of a control device of the hot press.

FIG. 3 is an enlarged view of a hot-head of the hot press of FIG. 1.

FIG. 4 is a diagram showing electrical connectivity among the temperature sensor, the control device, and the hot-head of the hot press of FIG. 1.

FIG. 5 is essentially a side view of a conventional hot press, showing an electronic device assemblage mounted on the hot press.

FIG. 6 is an enlarged, isometric view of a hot-head of the hot press of FIG. 5.

### DETAILED DESCRIPTION OF PREFERRED EMBODIMENTS

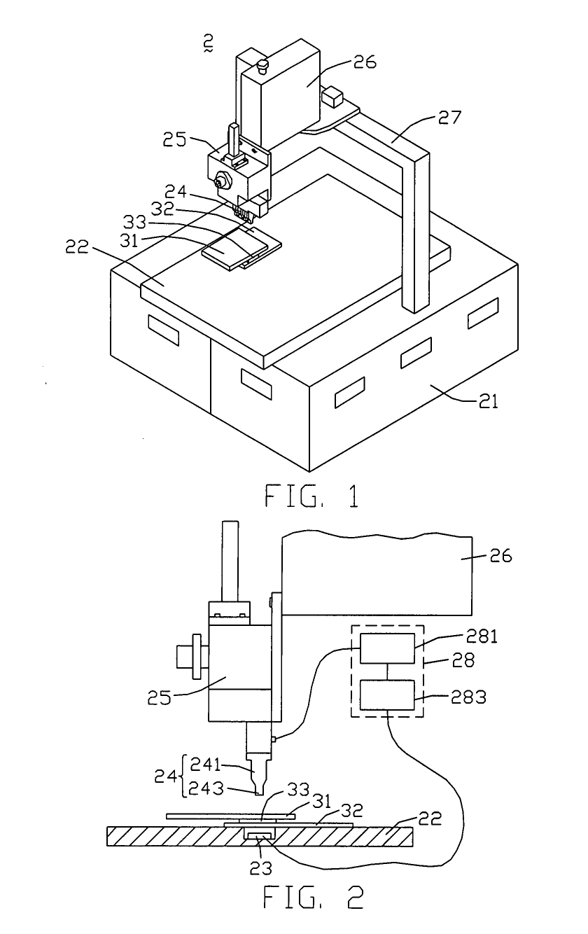

Referring to FIG. 1 and FIG. 2, aspects of a hot press 2 according to an exemplary embodiment of the present invention are shown. The hot press 2 is used to bond two electronic devices 31, 32 together via a piece of intervening bonding material 33. In the illustrated embodiment, the electronic device 31 is a printed circuit board, and the electronic device 32 is a liquid crystal panel. The bonding material 33 can for example be solder or an anisotropic conductive adhesive layer. In the illustrated embodiment, the bonding material 33 is an anisotropic conductive adhesive layer.

The hot press 2 includes a working table 21, an X-Y platform 22, a temperature sensor 23, a hot-head 24, a turret 25, a movable head 26, a frame 27, and a control device 28.

The X-Y platform 22 is mounted on the working table 21, and is configured to support the electronic devices 31, 32. The X-Y platform 22 can move along an X axis or a Y axis in a horizontal plane.

The temperature sensor 23 is disposed in the X-Y platform 22. The temperature sensor 23 can for example be an infrared temperature sensor. The temperature sensor 23 is configured to measure a temperature of bonding portions of the electronic devices 31, 32, and generate a temperature signal according to the measured temperature. Further, the temperature sensor 23 can measure more than one temperature corresponding to the bonding regions, in order to effectively deal with non-uniform temperature distribution at the bonding regions. In such case, the temperature sensor 23 can generate more than one temperature signal.

The frame 27 is generally U-shaped, and is mounted on the working table 21. The movable head 26 is mounted on the frame 27, and can move along the strip-shaped frame 27. The turret 25 is mounted on the movable head 26. The turret 25 can for example include a piston cylinder or the like. The hot-head 24 is mounted at a bottom end of the turret 25, and is used to press the electronic devices 31, 32 as well provide heat to the bonding portions of the electronic devices 31, 32. The turret 25 can drive the hot-head 24 to move in vertical directions. Due to the movable engagement of the movable head 26 with the frame 27, and the operation of the turret 25, the hot-head 24 can move vertically and along a single horizontal axis.

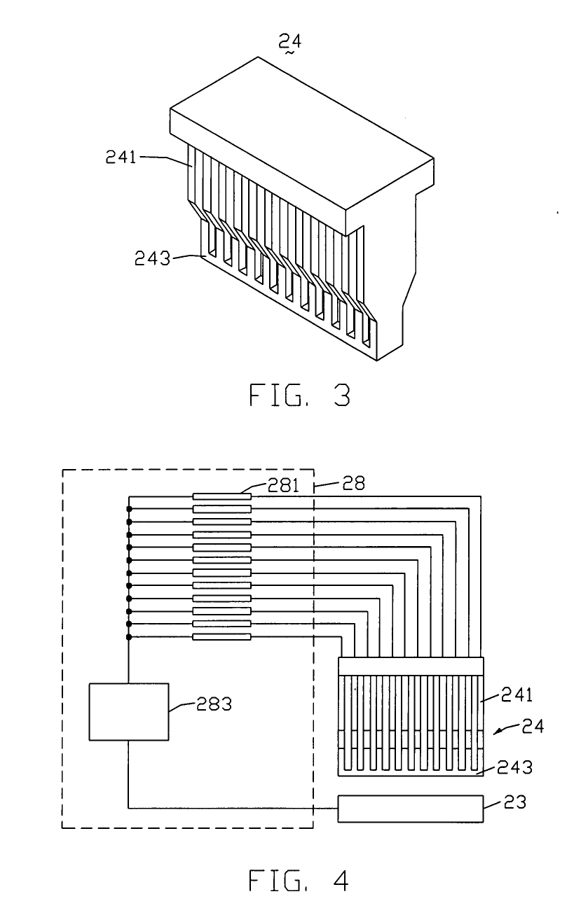

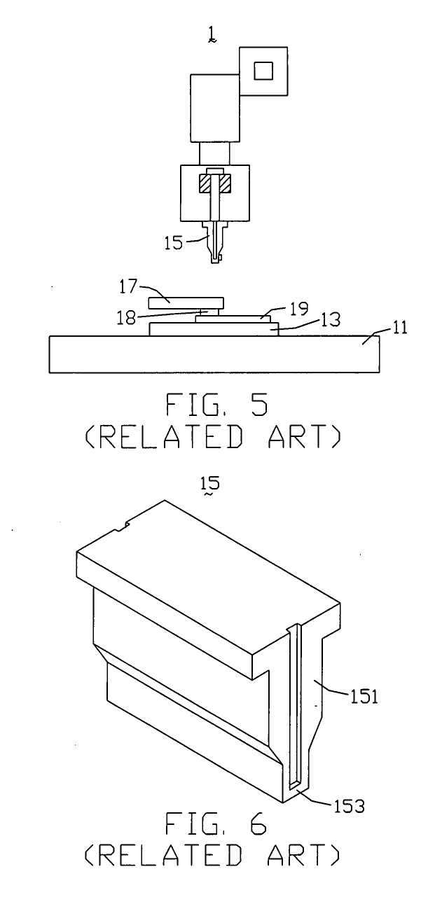

Referring also to FIG. 3, the hot-head 24 is a single piece, which includes a plurality of heating bodies 241 and a pressing end 243. The heating bodies 241 are arranged parallel to one another, and are spaced apart from each other at a constant pitch. The heating bodies 241 can be made from high heat conductive material, such as iron, copper or aluminum. Each heating body 241 is in the shape of a plate, which has a wide main portion, a tapering neck portion extending down from the main portion, and a narrow bottom portion. The narrow bottom portions of the heating bodies 241 are joined together by the pressing end 243.

Referring also to FIG. 4, the control device 28 is used to generate control signals to control the hot-head 24. The control device 28 includes a plurality of control units 281 and a comparator 283. The control units 281 are electrically connected with the comparator 283, and are electrically connected with the heating bodies 241 of the hot-head 24 respectively. The comparator 283 is electrically connected with the temperature sensor 23. The control units 281 provide control signals and electrical energy to the heating bodies 241. The comparator 283 is configured to receive information on the control signals from the control units 281 and the temperature signal(s) from the temperature sensor 23, compare the information on the control signals and the temperature signal(s), generate adjusting signals, and provide the adjusting signals to the control units 281. The adjusting signals adjust the control signals output by the control units 281, and thereby adjust the amount of heat provided by the heating bodies 241.

In operation, the control device 28 provides control signals and electrical energy to the heating bodies 241. The control signals can be pulse signals or constant voltage signals. The heating bodies 241 convert the electrical energy to heat energy under control of the control signals, and transmit the heat to the pressing end 243. The pressing end 243 transmits the heat to the bonding portions of the electronic devices 31, 32 and the bonding material 33. The temperature sensor 23 senses at least one temperature of the bonding portions of the electronic devices 31, 32, and provides at least one temperature signal to the comparator 283 of the control device 28. The comparator 283 compares the information on the control signals and the temperature signal(s), generates adjusting signals if and as necessary according to the results of the comparison, and provides the adjusting signals to the corresponding control units 281. Thereby, the control units 281 respectively adjust the amount of heat provided by the heating bodies 241, to make sure that a bottom face of the pressing end 243 has a substantially uniform surface temperature. Accordingly, the bonding portions of the electronic devices 31, 32 and the bonding material 33 have a substantially uniform temperature.

In summary, the hot-head 24 of the hot press 2 includes the plurality of heating bodies 241, with each heating body 241 being controlled by the respective control unit 281. By adjusting the amount of heat provided from each heating body 241 to the pressing end 243, the pressing end 243 can achieve a substantially uniform temperature. Thus, the bonding material 33 can be molten uniformly. Accordingly, the electronic devices 31, 32 can be bonded together via the bonding material 33 without defects.

In addition, the control device 28 in cooperation with the temperature sensor 23 can adjust the control signals provided to the heating bodies 241 in order to overcome non-uniformity of the temperature of the bonding portions of the electronic devices 31, 32 where such non-uniformity is due to circuit design and/or construction aberrations. In this circumstance, the temperature sensor 23 sends at least one temperature signal to the control devices 28, the at least one temperature signal relating to a temperature distribution of the bonding portions of the electronic devices 31, 32. The control device 28 adjusts the control signals provided to the heating bodies 243 according to the at least one temperature signal, so that the bonding portions of the electronic devices 31, 32 achieve a substantially uniform temperature distribution.

An exemplary hot pressing method employing the hot press 2 is as follows:

Before the hot press 2 is operated, the electronic devices 31, 32 are fixed on the X-Y platform 22, with the bonding material 33 being disposed between the bonding portions of the electronic devices 31, 32. The temperature sensor 23 in the X-Y platform 22 is located directly beneath the bonding portions of the electronic devices 31, 32. Either or both of the movable head 26 and the X-Y platform 22 are moved, so that the turret 25 and the hot-head 24 are aligned with the bonding portions of the electronic devices 31, 32. The turret 25 moves the hot-head 24 down until the pressing end 243 presses on the bonding portion of the electronic device 31. The control units 281 of the control device 28 respectively control the heating bodies 241 to convert electrical energy to heat energy, and transfer the heat to the pressing end 243. Thereby, the bonding material 33 is melted. The temperature sensor 23 senses a temperature of the bonding portions of the electronic devices 31, 32, and provides a temperature signal to the comparator 283 of the control device 28. The comparator 283 compares the information on the control signals of the control units 281 with the temperature signal, generates adjusting signals according to results of the comparison, and provides the adjusting signals to the control units 281. Thereby, the control units 281 control the heating bodies 241 such that the pressing end 243 has a uniform temperature.

In an alternative method, the control units 281 of the control device 28 respectively control the heating bodies 241 to convert electrical energy to heat energy and transfer the heat to the pressing end 243 prior to the turret 25 moving the hot-head 24 down until the pressing end 243 presses on the bonding portion of the electronic device 31.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A hot press for bonding at least two electronic devices together, the hot press comprising:
a hot-head comprising a plurality of heating members and a pressing end joining same ends of the heating members, the pressing end being configured for pressing a bonding portion of one of the electronic devices, the heating members being configured for converting input electrical energy into heat and transferring the heat to the bonding portion of said one of the electronic devices via the pressing end; and
a control device electrically connected with the heating members and configured for controlling the amount of the heat generated by each heating member.

2. The hot press as claimed in claim 1, further comprising an X-Y platform, the X-Y platform being configured for supporting the electronic devices.

3. The hot press as claimed in claim 2, further comprising a temperature sensor disposed in the X-Y platform and communicatively coupled to the control device, the temperature sensor configured for measuring at least one temperature of at least one area corresponding to the bonding portions of the electronic devices, and transmitting the at least one temperature to the control device.

4. The hot press as claimed in claim 3, wherein the temperature sensor is an infrared temperature sensor.

5. The hot press as claimed in claim 2, wherein the control device comprises a comparator, the comparator being electrically connected with the temperature sensor.

6. The hot press as claimed in claim 5, wherein the control device further comprises a plurality of control units, the control units being electrically connected with the heating members respectively, and being configured for providing control signals and electrical energy to the heating members.

7. The hot press as claimed in claim 2, further comprising a working table, the X-Y platform being disposed on the working table and being capable of moving along an X axis and a Y axis relative to the working table.

8. The hot press as claimed in claim 1, further comprising a frame mounted on the working table.

9. The hot press as claimed in claim 8, further comprising a movable head mounted on the frame, the movable head being capable of moving along a single horizontal axis that is parallel to the frame.

10. The hot press as claimed in claim 9, further comprising a turret mounted on the movable head.

11. The hot press as claimed in claim 10, wherein the turret comprises a piston cylinder.

12. The hot press as claimed in claim 10, wherein the hot-head is mounted on the turret, and the turret is configured to drive the hot-head to move along vertical directions.

13. The hot press as claimed in claim 1, wherein the heating members are made from a material selected from the group consisting of iron, copper, and aluminum.

14. The hot press as claimed in claim 1, wherein the heating members are arranged parallel to one another and are spaced apart from each other at a constant pitch.

15. A hot pressing method for bonding two electronic devices together, the method comprising:
providing a hot press, the hot press comprising a control device and a hot-head, the hot-head comprising a plurality of heating members and a pressing end;
providing two electronic devices and bonding material sandwiched between bonding portions of the electronic devices;
adjusting a position of the hot-head relative to a position of the bonding portions of the electronic devices so that the hot-head is aligned with the bonding portions;
driving the hot-head so that the pressing end presses the bonding portion of one of the electronic devices;
the control device providing control signals to drive the heating members to generate heat, such that the pressing end provides the heat to the bonding portion of said one of the electronic devices; and
the control device controlling the amount of heat generated by each heating member, such that the bonding material is uniformly heated.

16. The method as claimed in claim 15, wherein the hot press further comprises a temperature sensor, and the control device comprises a comparator, the method further comprising:
the temperature sensor measuring at least one temperature of at least one area corresponding to the bonding portions of the electronic devices, and generating at least one temperature signal;
the comparator comparing information on the control signals and the at least one temperature signal, generating at least one adjusting signal according to at least one result of the comparison, and providing the at least one adjusting signal to the control device; and
the control device controlling the amount of heat generated by at least one of the heating members according to the at least one adjusting signal.

17. The method as claimed in claim 15, wherein the adjusting of the position of the hot-head comprises at least one of moving the hot-head along a single horizontal axis, and moving the electronic devices in a horizontal X-Y plane.

18. A hot press machine for bonding at least two electronic devices together, the hot press machine comprising:
a one-piece hot-head comprising a plurality of heating members and a pressing end joining same ends of the heating members, the heating members configured for individually generating heat;
a temperature sensor configured for measuring at least one temperature of at least one area corresponding to portions of the electronic devices located where the pressing end contacts one of the electronic devices; and
a control device configured for receiving the measured at least one temperature and controlling each heating member to generate a particular amount of heat having regard to the measured at least one temperature.
